(19) United States
(12) Patent Application Publication
(10) Pub. No.: US 2013/0226363 A1
(43) Pub. Date: Aug. 29, 2013

(54) SHUT-DOWN CONTROLLING SYSTEM FOR POWER DISTRIBUTION UNIT

(71) Applicant: HSIEN-HSUN LIU, TAIPEI (TW)

(72) Inventor: HSIEN-HSUN LIU, TAIPEI (TW)

(73) Assignee: CYBER POWER SYSTEMS INC., TAIPEI (TW)

(21) Appl. No.: 13/403,435

(22) Filed: Feb. 23, 2012

(51) Int. Cl. G06F 1/26

(52) U.S. Cl. 700/297

(57) ABSTRACT

A shut-down controlling system for power distribution unit (PDU) has a computer a PDU and multiple electric apparatus connected to the PDU. The PDU has multiple outlets and stores a shut-down controlling procedure and a shut-down period for each of the outlet. The PDU automatically communicates with the electric apparatus and obtains the actual shut-down period of the present electric apparatus. The PDU further determines whether the preset shut-down period is larger than the actual shut-down. If yes, the PDU cuts out the AC power source of the selected outlet when the preset shut-down period is achieved. If not, the PDU cancels the shut-down command and notifies the computer. Therefore, a manager will resets the shut-down period of the selected outlet to ensure that each electric apparatus has enough time to complete the shut-down procedure.

### BACKGROUND OF THE INVENTION

1. Field of the Invention

The present invention relates to a shut-down controlling system for a power distribution unit (hereinafter PDU), especially to a shut-down controlling system for a PDU that ensures that electric apparatuses connected to the PDU have enough time to complete shut-down procedure.

2. Description of Related Art

To easily shut down and power on multiple computers or server at the same time, a power strip is proposed. The power strip has an AC power input, multiple AC power outlets and a power breaker. The power breaker is serially connected between the AC power input and the multiple AC power outlets. When the power breaker turns on, the AC power source connected to the AC power input is further output to each of the AC power outlets. On the contrary, all AC power outlets are not output the AC power when the power breaker turns off. Therefore, electronic apparatuses respectively connected to corresponding AC power outlets shut down and power on at the same time by turning on or off the power breaker of the power strip. However, parts of the electric apparatuses connected to the power strip have to be shut down or power on respectively. Therefore, an amended power strip further has multiple power breakers. The power breakers are connected to the corresponding AC power outlets to independently power on or off the corresponding AC power outlets. The manager manually switches the power breakers to determine shut-down sequence and power-on sequence for the electric apparatuses.

The power strip provides power breakers for the manager, the manager has to remember the shut-down sequence and the power-on sequence for the electric apparatuses. For large numbers of the electric apparatuses, using the above power strips is not convenient.

Recently, a power distribution unit (hereinafter PDU) is proposed. With reference to FIG. 5, the PDU (50) has an AC power input, multiple AC power outlets (51) and a controlling unit (52). When the AC power input is connected to the AC power source, each of AC power outlets outputs the AC power source. The controlling unit (52) stores parameters including a shut-down time and a power-on time for each AC power outlet (51). The manager previously presets the shut-down times and power-on times of the PDU (50). When the shut-down time is achieved, the controlling unit (52) sequentially interrupts outputting the AC power of the AC power outlets (51) to shut down the electric apparatuses (30) in sequence. Therefore, the PDU (50) can automatically shut down the electric apparatuses (30) in sequence and makes sure that each electric apparatus has enough time to complete a shut-down procedure.

Based on the foregoing description, the manager conveniently shuts down the electric apparatuses by using the PDU. However, the shut-down period of each electric apparatus is not fixed, so the manager has to change the parameters of the PDU. Therefore, the PDU has to requires a convenient controlling system to preset parameters.

### SUMMARY OF THE INVENTION

The main objective of the present invention is to provide a shut-down controlling system for a PDU to ensure that electric apparatuses shut down completely.

The shut-down controlling system for power distribution unit (PDU) has a computer a PDU and multiple electric apparatus connected to the PDU. The PDU has multiple outlets and stores a shut-down controlling procedure and a shut-down period for each of the outlet. The PDU automatically sends the notification of cutting power to the electric apparatus when the computer outputs the shut-down command The electric apparatus receives the notification of cutting power, the response of cutting power to the PDU. Since the response of the cutting power has the actual shut-down period of the present electric apparatus, the PDU determines whether the preset shut-down period is larger than the actual shut-down. If yes, the PDU cuts out the AC power source of the selected outlet when the preset shut-down period is achieved. If not, the PDU cancels the shut-down command and notifies the computer. Therefore, a manager will resets the shut-down period of the selected outlet to ensure that each electric apparatus has enough time to complete the shut-down procedure.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a controlling system for a PDU in accordance with the present invention;

FIG. 2 is functional block view of the PDU of the controlling system in accordance with the present invention;

FIG. 3 is a time sequence drawing of a first embodiment of the shut-down controlling system in accordance with the present invention; and

FIG. 4 is a time sequence drawing of a second embodiment of the shut-down controlling system in accordance with the present invention; and

FIG. 5 is a schematic view of a conventional controlling system in accordance with the prior art.

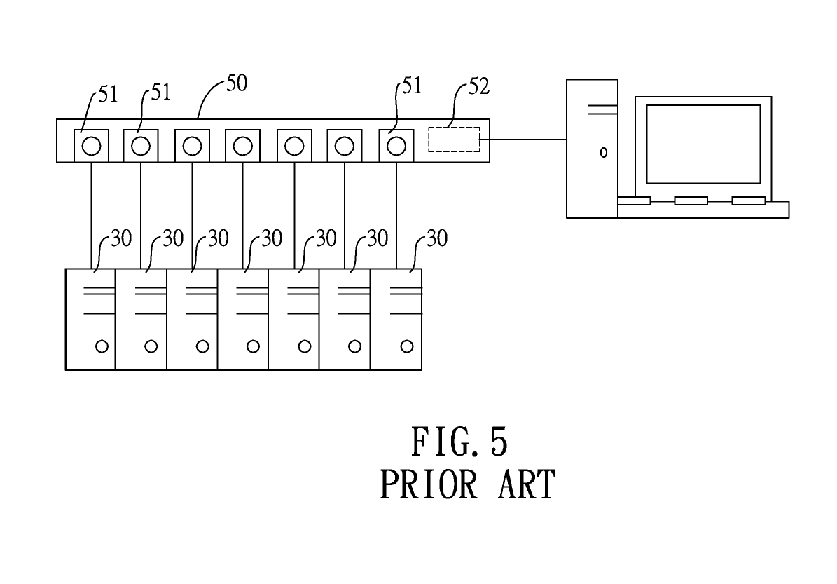

### DETAILED DESCRIPTION OF THE PREFERRED EMBODIMENT

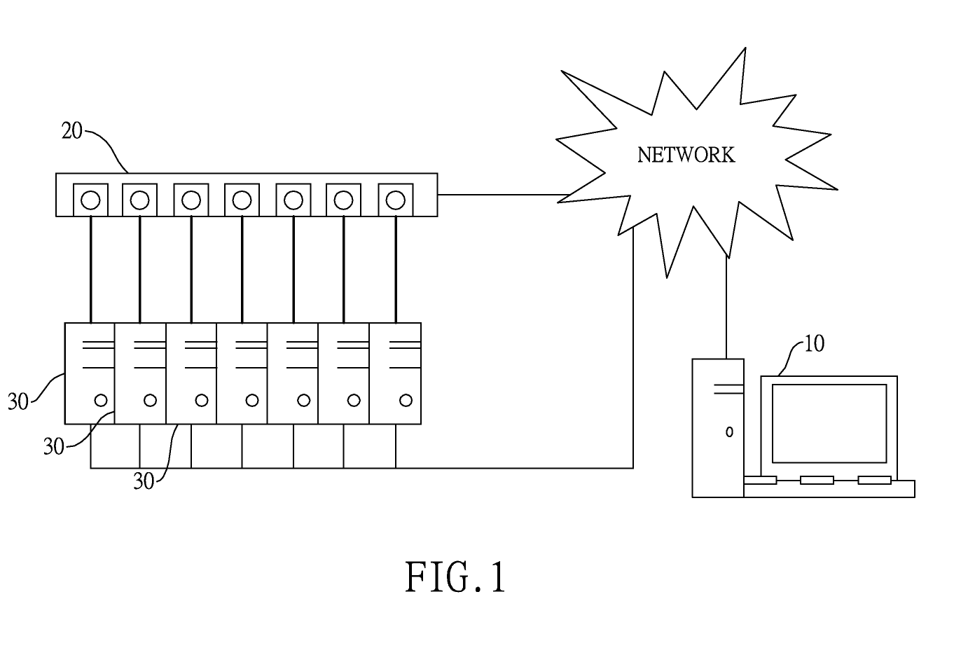

With reference to FIG. 1, a controlling system in accordance with the present invention has a computer (10), a power distribution unit (PDU) (20) and multiple electric apparatuses (30). The computer links to a network such as Internet or Intranet. The PDU (20) links to the computer (30) through the network. The electric apparatuses (30) are connected to the PDU (20) to have AC power source, and link to the computer (10).

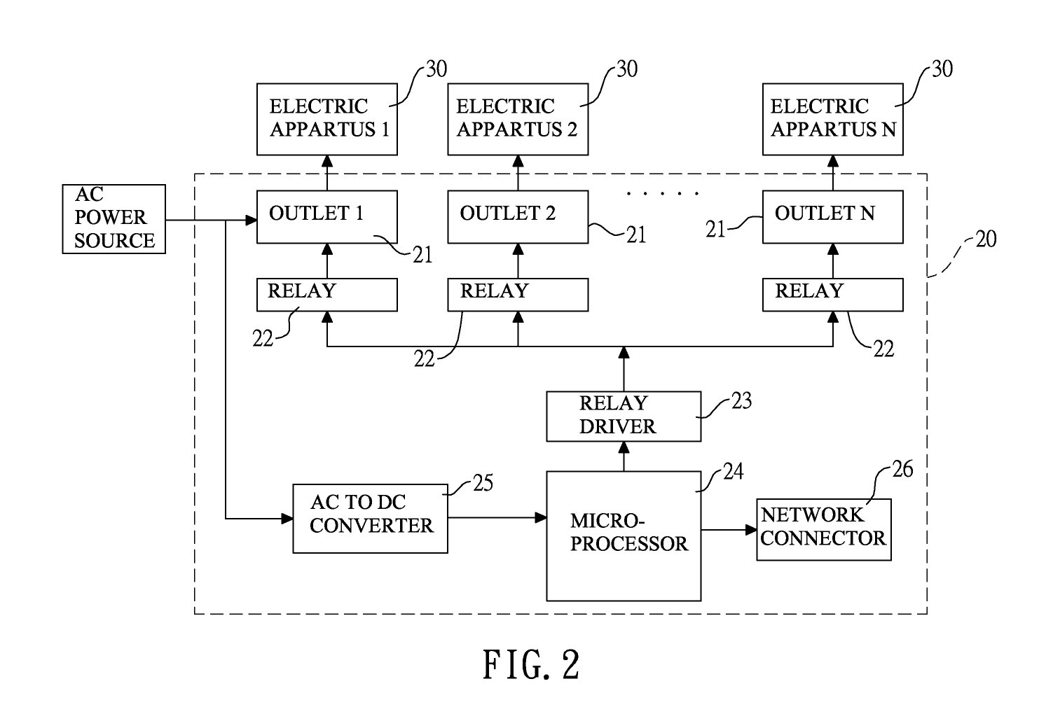

With further reference to FIG. 2, the PDU (20) has multiple outlets (21), relays (22), a relay driver (23), a microprocessor (24), an AC to DC converter (25) and a network connector (26).

The outlets (21) are connected to an external AC power source and each of which is connected to the corresponding relay (22). The microprocessor (24) drives the relays (22) through the relay driver (23). The AC to DC power converter (24) is connected to the AC power source and the microprocessor (24), and converts the AC power source to DC power source. The DC power source is supplied to the microprocessor (24). The network connector (26) is connected to the microprocessor (24) so the microprocessor (24) links to the computer (10) through the network connector (26) and the network. The microprocessor (24) stores parameters including a shut-down period for each of the outlets (21), and a shut-down controlling procedure.

The electric apparatuses (30), such as computer or server, are respectively connected to the corresponding outlets (21) to have the AC power source, and link to the computer (10). Therefore, the PDU communicates with the electronic apparatuses through the network and the electronic apparatuses communicates with the PDU through network, too.

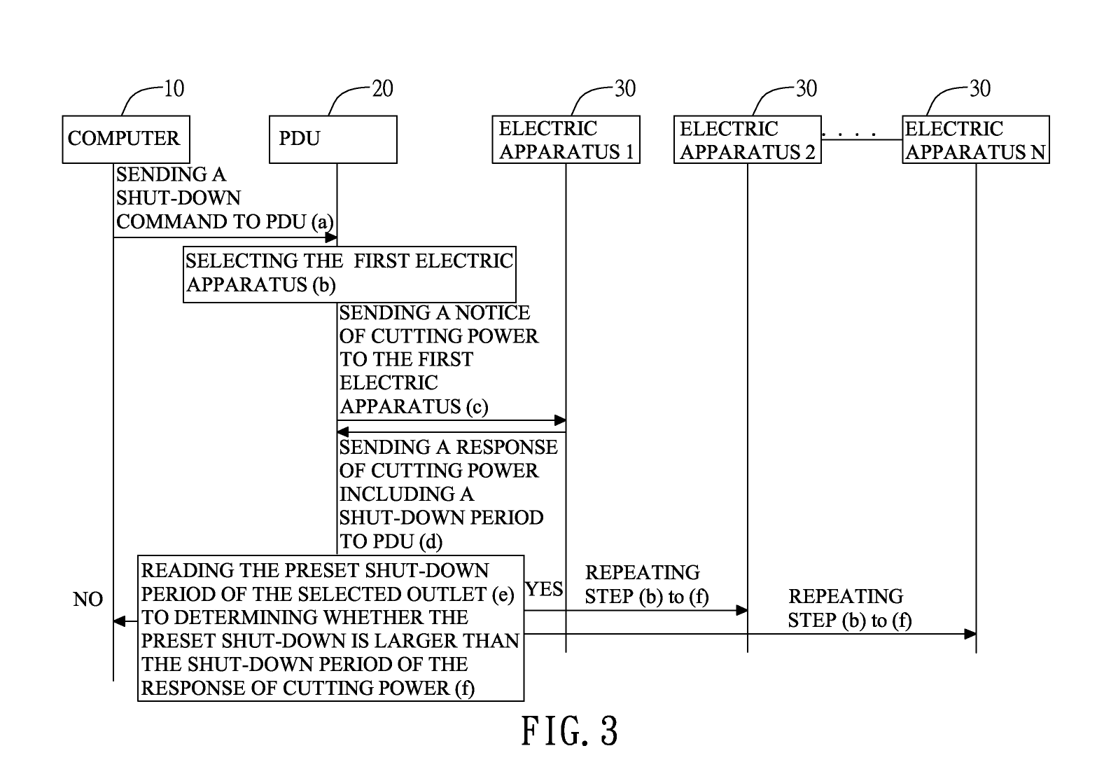

With further reference to FIG. 3, a flow chart of a preferred embodiment of the shut-down controlling procedure of the microprocessor (24) of the PDU (20) has steps of:

(a) receiving a shut-down command from the computer (10) through the network;

(b) selecting one of the outlet (21) to cut out AC power source;

(c) sending a notice of cutting power to one electric apparatus (30) corresponding to the selected outlet (21); wherein the notice of cutting power is directly transmitted to the corresponding electric apparatus (30) through the network or indirectly transmitted to the corresponding electric apparatus (30) through the computer (20); wherein in a preferred embodiment, the notice of cutting power is formed of SNMP format;

(d) receiving a response of cutting power including a shut-down period from the electric apparatus (30) corresponding to the selected outlet (21); wherein in a preferred embodiment, the response of cutting power is formed of SNMP format;

(e) reading the preset shut-down period of the selected outlet (21);

(f) determining whether the preset shut-down period is larger than the shut-down period of the response of cutting power; if a determining result is positive, the preset shut-down is not changed; but if the determining result is negative, canceling the shut-down command from the computer and ending the shut-down controlling procedure; and

(g) going to step (b) until all outlets (21) cut out the AC power source.

Since the PDU (20) also stores a shut-down sequence list listing shut-down sequence of the outlets, in the step (b), one outlet (21) is selected according to the shut-down sequence.

Based on the foregoing description, the PDU automatically sends the notification of cutting power to the electric apparatus when the computer outputs the shut-down command. After the electric apparatus receives the notification of cutting power, the response of cutting power is sent to the PDU. Since the response of the cutting power has the actual shut-down period of the present electric apparatus, the PDU automatically determines whether the preset shut-down period is larger than the actual shut-down. If the preset shut-down period is larger than the actual shut-down, the PDU cuts the AC power source through the relay connected to the selected outlet. Therefore, the electric apparatus has enough time to shut down completely. On the contrary, if the preset shut-down period is smaller than the actual shut-down, the PDU cancels the shut-down command and notifies the computer. Therefore, a manager will resets the shut-down period of the selected outlet to ensure that each electric apparatus has enough time to complete the shut-down procedure.

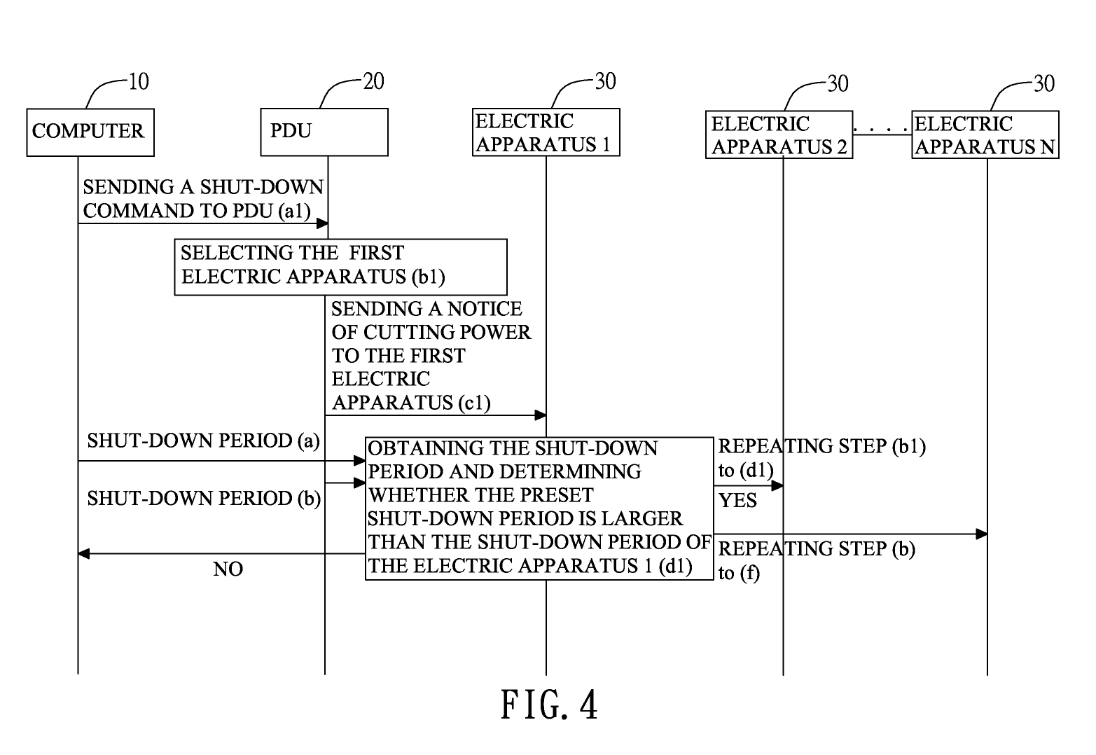

With reference to FIG. 4, a flow chart of a second embodiment of the shut-down controlling procedure of the microprocessor (24) of the PDU (20) has steps of:

(a1) receiving a shut-down command from the computer (10) through the network;

(b1) selecting one of the outlet (21) to cut out AC power source;

(c1) sending a notice of cutting power to one electric apparatus (30) corresponding to the selected outlet (21); wherein the notice of cutting power is directly transmitted to the corresponding electric apparatus (30) through the network or indirectly transmitted to the corresponding electric apparatus (30) through the computer (20); wherein in a preferred embodiment, the notice of cutting power is formed of SNMP format; wherein the electric apparatus (30) obtains the shut-down period of the selected outlet and determines whether the shut-down period of the notice of cutting power is larger than the present shut-down period stored the electric apparatus; if a determining result is positive, the electric device starts to shunt down; but if the determining result is negative, the electric apparatus outputs a canceling command to the PDU through network;

(d1) waiting to receive the canceling command from the electric apparatus (30) corresponding to the selected outlet (21) within the shut-down period of the selected outlet; and ending the shut-down controlling procedure if the canceling command is received;

(e1) going to step (b1) until all outlets (21) cut out the AC power source.

Since In the foregoing step (c1), the PDU (20) may store the shut-down period for each of the outlets of the PDU (20). Therefore, in the foregoing step (c1), the electric apparatus (30) obtains the shut-down period of the selected outlet from the notice of cutting power.

In other implementation, the computer (10) may store the shut-down period for each of the outlets of the PDU (20). The electric apparatus (30) obtains the obtains the shut-down (a) of the selected outlet from the computer (10) after receiving the notice of the cutting power.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A shut-down controlling system for power distribution unit (PDU), comprising:
a computer linking to a network;
a PDU linking to the computer through the network and having multiple outlets and storing a shut-down controlling procedure, a shut-down period and power-on period for each of the outlets; and
multiple electric apparatuses respectively connected to the corresponding outlets of the PDU to have AC power source, and linking to the computer and the PDU through the network; wherein
the shut-down controlling procedure of the PDU comprises steps of:
(a) receiving a shut-down command from the computer through the network;
(b) selecting one of the outlet to cut out AC power source;
(c) sending a notice of cutting power to one electric apparatus corresponding to the selected outlet;
(d) receiving a response of cutting power including a shut-down period from the electric apparatus corresponding to the selected outlet;
(e) reading the preset shut-down period of the selected outlet;
(f) determining whether the preset shut-down is larger than the shut-down period of the response of cutting power; if a determining result is positive, the preset shut-down is not changed; but if the determining result is negative, canceling the shut-down command from the computer and ending the shut-down controlling procedure; and
(g) going to step (b) until all outlets cut out the AC power source.

2. The shut-down controlling system as claimed in claim 1, wherein in step (c), the notice of cutting power is directly transmitted to the corresponding electric apparatus through the network.

3. The shut-down controlling system as claimed in claim 1, wherein in step (c), the notice of cutting power is indirectly transmitted to the corresponding electric apparatus through the computer.

4. The shut-down controlling system as claimed in claim 1, wherein the notice of cutting power is formed of SNMP format.

5. The shut-down controlling system as claimed in claim 2, wherein the notice of cutting power is formed of SNMP format.

6. The shut-down controlling system as claimed in claim 3, wherein the notice of cutting power is formed of SNMP format.

7. The shut-down controlling system as claimed in claim 1, wherein the PDU further stores a shut-down sequence list listing shut-down sequence of the outlets and in the step (b) one outlet is selected according to the shut-down sequence.

8. The shut-down controlling system as claimed in claim 1, wherein the PDU further stores a shut-down sequence list listing shut-down sequence of the outlets and in the step (b) one outlet is selected according to the shut-down sequence.

9. The shut-down controlling system as claimed in claim 4, wherein the PDU further stores a shut-down sequence list listing shut-down sequence of the outlets and in the step (b) one outlet is selected according to the shut-down sequence.

10. A shut-down controlling system for power distribution unit (PDU), comprising:
a computer linking to a network;
a PDU linking to the computer through the network and having multiple outlets and storing a shut-down controlling procedure, a shut-down period and power-on period for each of the outlets; and
multiple electric apparatuses respectively connected to the corresponding outlets of the PDU to have AC power source, and linking to the computer and the PDU through the network; wherein
the shut-down controlling procedure of the PDU comprises steps of:
(a) receiving a shut-down command from the computer through the network;
(b) selecting one of the outlets to cut out AC power source;
(c) sending a notice of cutting power to one electric apparatus corresponding to the selected outlet; wherein the electric apparatus obtains the shut-down period of the selected outlet and further determines whether the shut-down period of the selected outlet is larger than the present shut-down period stored the electric apparatus; if a determining result is positive, the electric device starts to shunt down; but if the determining result is negative, the electric apparatus outputs a canceling command to the PDU through network;
(d) waiting to receive the canceling command from the electric apparatus corresponding to the selected outlet within the shut-down period of the selected outlet; and stopping to cut out the selected outlet if the canceling command is received; and
(e) going to step (b) until all outlets cut out the AC power source.

11. The shut-down controlling system as claimed in claim 10, wherein the PDU also stores the shut-down period for each of the outlets of the PDU, so that the electric apparatus obtains the shut-down period of the selected outlet from the PDU after receiving the notice of cutting power.

12. The shut-down controlling system as claimed in claim 10, wherein the computer also stores the shut-down period for each of the outlets of the PDU, so that the electric apparatus obtains the shut-down period of the selected outlet from the computer through network after receiving the notice of cutting power.

13. The shut-down controlling system as claimed in claim 11, wherein in step (c), the notice of cutting power is directly transmitted to the corresponding electric apparatus through the network.

14. The shut-down controlling system as claimed in claim 12, wherein in step (c), the notice of cutting power is directly transmitted to the corresponding electric apparatus through the network.

15. The shut-down controlling system as claimed in claim 11, wherein in step (c), the notice of cutting power is indirectly transmitted to the corresponding electric apparatus through the computer.

16. The shut-down controlling system as claimed in claim 12, wherein in step (c), the notice of cutting power is indirectly transmitted to the corresponding electric apparatus through the computer.

17. The shut-down controlling system as claimed in claim 10, wherein the notice of cutting power is formed of SNMP format.

18. The shut-down controlling system as claimed in claim 11, wherein the notice of cutting power is formed of SNMP format.

19. The shut-down controlling system as claimed in claim 12, wherein the notice of cutting power is formed of SNMP format.

20. The shut-down controlling system as claimed in claim 10, wherein the PDU further stores a shut-down sequence list listing shut-down sequence of the outlets and in the step (b) one outlet is selected according to the shut-down sequence.

21. The shut-down controlling system as claimed in claim 11, wherein the PDU further stores a shut-down sequence list listing shut-down sequence of the outlets and in the step (b) one outlet is selected according to the shut-down sequence.

22. The shut-down controlling system as claimed in claim 12, wherein the PDU further stores a shut-down sequence list listing shut-down sequence of the outlets and in the step (b) one outlet is selected according to the shut-down sequence.
